(19) United States
(12) Patent Application Publication
(10) Pub. No.: US 2023/0125019 A1
(43) Pub. Date: Apr. 20, 2023

(54) ADVANCED HUB APPARATUS FOR MOBILE COMPUTER

(71) Applicant: Kien Hoe Daniel Chin, Fremont, CA (US)

(72) Inventor: Kien Hoe Daniel Chin, Fremont, CA (US)

(21) Appl. No.: 17/505,541

(22) Filed: Oct. 19, 2021

(51) Int. Cl. G06F 1/16

(52) U.S. Cl. CPC G06F 1/1632

(57) ABSTRACT

A port extension apparatus for extending ports of an end-user device comprising: a connecting port module for connecting to an end-user device, the connecting port module having first and second port units; a first video port module operatively connecting to the first port unit; a data transmission control module operatively connecting to the second port unit via a first data transmission port of the data transmission control module; a second video port module operatively connecting to a second data transmission port of the data transmission control module; and a data port module operatively connecting to a third data transmission port of the data transmission control module; wherein when a to-be-connected device connects to the first video port module, the first video port module and the connecting port module form a transmission path enabling video data transmission between the to-be-connected device and the end-user device; when a to-be-connected device connects to the second video port module, the data transmission control module controls video data transmission between the to-be-connected device and the end-user device; and when a to-be-connected device connects to the data port module, the data transmission control module controls data transmission between the to-be-connected device and the end-user device.

### FIELD OF INVENTION

The present invention relates to hub apparatus for mobile computer. The present invention is further ergonomic and discreet, and designed of advanced hub apparatus for maximum video performance.

### BACKGROUND

The benefits of increasingly lighter and thinner Apple™ laptops come with some significant tradeoffs. While earlier models had multiple input options, including HDMI, DisplayPort, ethernet, USB A, inter alia, the last few iterations have been reduced to two USB C ports on the 13″ MacBooks and four USB C ports on 16″ MacBooks. Especially in this time where many more people are working remotely instead of at an office, a simple and discreet solution for attaching other sorts of input into these laptops is needed. Such a user often wishes to connect the laptop to one or more monitors, requiring several fast video connections not available on the laptops as is.

Not only do these the compact laptops have no room for expanded components, they do not have room for many connector sockets. To remedy the situation, adapter hubs that have multiple sockets of different purposes, such as USB for data transfer, USB for charging, HDMI or DisplayPort for external monitor, etc., are invented. However, past designs have been bulky and cumbersome while only providing a limited number of additional ports. Moreover, due to the switch-based format of past adapter hub designs, video and other high data flow attachments are prone to poor performance the more items are attached to the hub. Often, the user would need to purchase multiple adapter hubs in order to attach the needed amount of inputs and to increase the quality of high-data inputs such as for video. Even if the user acquired sufficient adapters to attach everything they required, the result would be messy, bulky, and difficult to set up.

Thus, it is desirable that an ergonomic adapter hub be made that provides all necessary inputs while furnishing high performance video attachments.

### OBJECTIVE OF THE INVENTION

It is an object of this invention to create an ergonomic, lightweight, and discreet attachment apparatus that provides a simple solution to the limited number of inputs on Apple™ laptops.

It is an additional object of this invention to create said attachment apparatus which can be attached to and removed from said laptops quickly without tools.

It is an additional object of this invention to provide faster and smoother video performance than prior adapter hubs could supply.

### SUMMARY OF THE INVENTION

In one aspect of the invention, a port extension apparatus is disclosed for extending ports of an end-user device comprising: a connecting port module for connecting to an end-user device, the connecting port module having first and second port units; a first video port module operatively connecting to the first port unit; a data transmission control module operatively connecting to the second port unit via a first data transmission port of the data transmission control module; a second video port module operatively connecting to a second data transmission port of the data transmission control module; and a data port module operatively connecting to a third data transmission port of the data transmission control module; wherein when a to-be-connected device connects to the first video port module, the first video port module and the connecting port module form a transmission path enabling video data transmission between the to-be-connected device and the end-user device; when a to-be-connected device connects to the second video port module, the data transmission control module controls video data transmission between the to-be-connected device and the end-user device; and when a to-be-connected device connects to the data port module, the data transmission control module controls data transmission between the to-be-connected device and the end-user device.

In one embodiment, the end-user device is a display device. In one embodiment, the first video port module when operatively connecting to the first port unit is further consist of a mode conversion unit between the first video port module and the first port unit. In one embodiment, the mode conversion unit is comprised of a video feed conversion unit that converts video feed from DisplayPort standard to HDMI port standard. In one embodiment, the mode conversion unit is comprised of jitter cleaning module to improve the quality of the video transmission data. In one embodiment, the apparatus further comprising: a second data port module operatively connecting to a fourth data transmission port of the data transmission control module; and a memory card R/W (read/write) module operatively connecting to at least one data read/write port of the data transmission control module. In one embodiment, the port extension apparatus further comprising: a third data port module operatively connecting to a fifth data transmission port of the data transmission control module. In one embodiment, the port extension apparatus further comprising: a fourth data port module operatively connecting to a sixth data transmission port of the data transmission control module. In one embodiment, the port extension apparatus further comprising: a fifth data port module operatively connecting to a seventh data transmission port of the data transmission control module. In one embodiment, the port extension apparatus as described in claim 1, wherein the first video port module comprises an HDMI (High-Definition Multimedia Interface) port, and a a DP (Display Port). In one embodiment, the port extension apparatus as described in claim 1, wherein the second video port module comprises an HDMI port, and a Display Port. In one embodiment, the first data port module comprises a Type-C female port or a Lighting female port. In one embodiment, the second data port module comprises a Type-C female port or a Lighting female port. In one embodiment, the third data port module comprises a USB female port.

In another aspect of the invention, a port extension apparatus for extending ports of an end-user device is disclosed comprising a main hub and an extension hub; wherein the main and extension hubs comprises rectangular prism chassis that have multiple openings on sides for ports; wherein the main hub, from left to right looking in, comprises a first DisplayPort port, a first HDMI port, a second DisplayPort port, a second HDMI port, an Ethernet port, 3 USB-C ports, 3 USB-A ports, a micro memory card port and a memory card port; wherein the main hub further comprises a dual Thunderbolt ports on a right side of the main hub that in turn connects to a dual Thuderbolt connector; wherein the extension hub, from left to right, comprises a DisplayPort port and a HDMI port; wherein the extension hub further comprise a single Thunderbolt port on a left side of the extension hub that in turn connects to a single Thunderbolt connector; wherein the main hub further comprises a first circuit board on which the first DisplayPort port, first HDMI port, second DisplayPort port, second HDMI port, Ethernet port, 3 USB-C ports, 3 USB-A ports, micro memory card port, memory card port, and dual Thunderbolt ports are mounted, and wired; wherein the extension hub further comprises a second circuit board on which the DisplayPort port, HDMI port, and single Thunderbolt port are mounted and wired; wherein the main hub further comprises three screws that attach the first circuit board to the main rectangular prism chassis and are disposed at an equidistance;

wherein the extension hub further comprises one screw that attach the second circuit board to the extension rectangular prism chassis; wherein the main hub further comprises a first magnet module that secures the main hub to a laptop; wherein the extension hub further comprises a second magnet module that secures the extension hub to a laptop; wherein the main hub further comprises two rubber pads and four screws that attach the two rubber pads to a bottom of the main rectangular prism chassis at an equidistance; wherein the extender hub further comprises a rubber pad and two screws that attach the rubber pad to a bottom of the extension rectangular prism chassis.

### BRIEF DESCRIPTION

The present invention will be understood and appreciated more fully from the following detailed description taken in conjunction with the drawings in which:

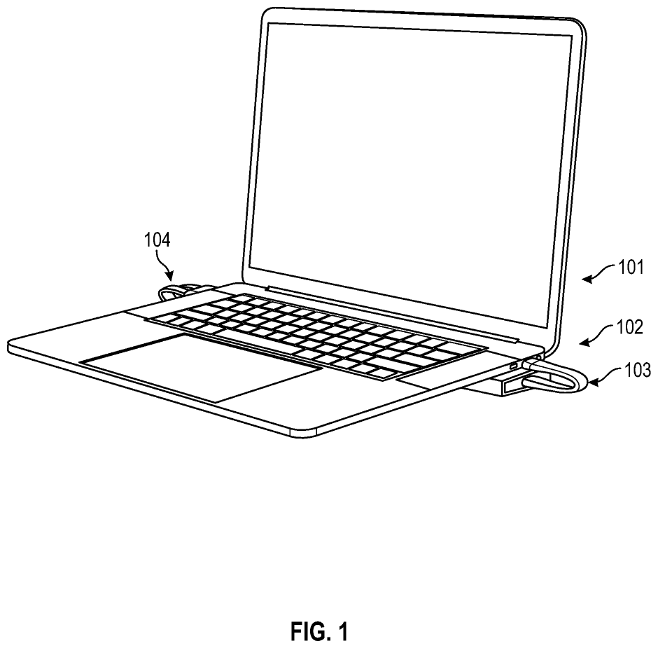

FIG. 1 illustrates an embodiment of the present invention fully assembled and attached to a MacBook.

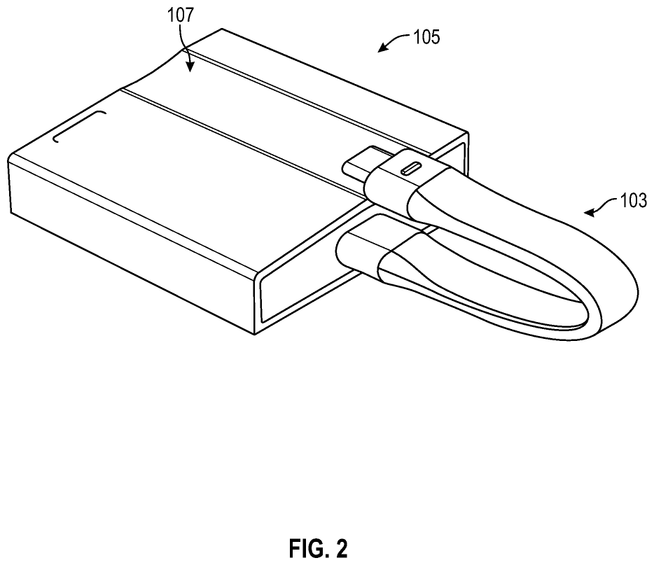

FIG. 2 illustrates the extender portion of an embodiment of the present invention, for use with 16″ MacBook.

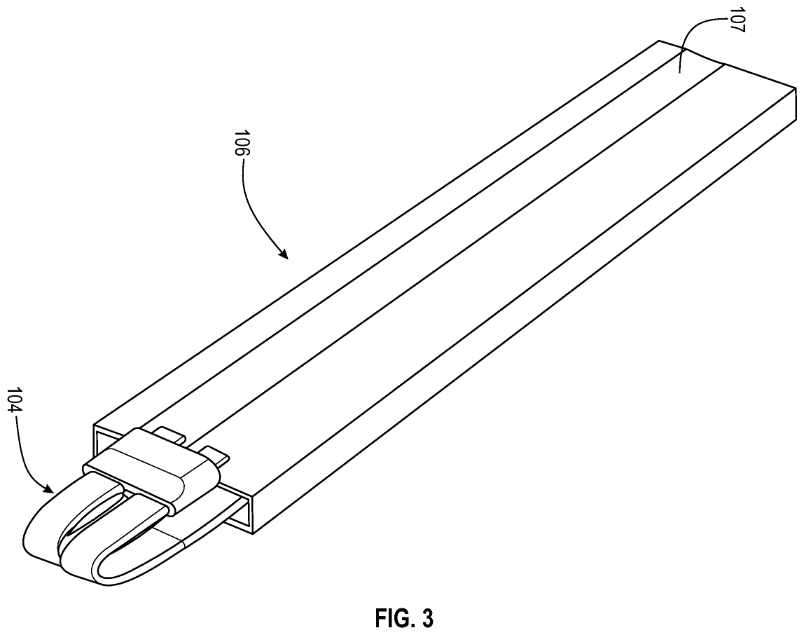

FIG. 3 illustrates the main section of an embodiment of the present invention, that comprises the adapter hub for use with a MacBook.

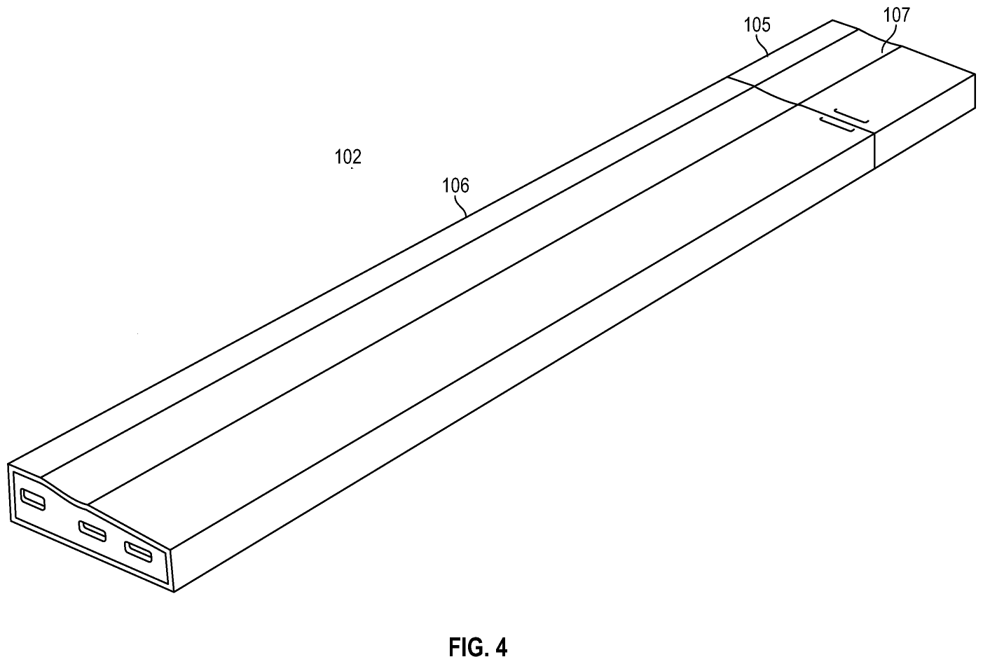

FIG. 4 illustrates a front/top view of an embodiment of the present invention with the extender portion attached to the main portion.

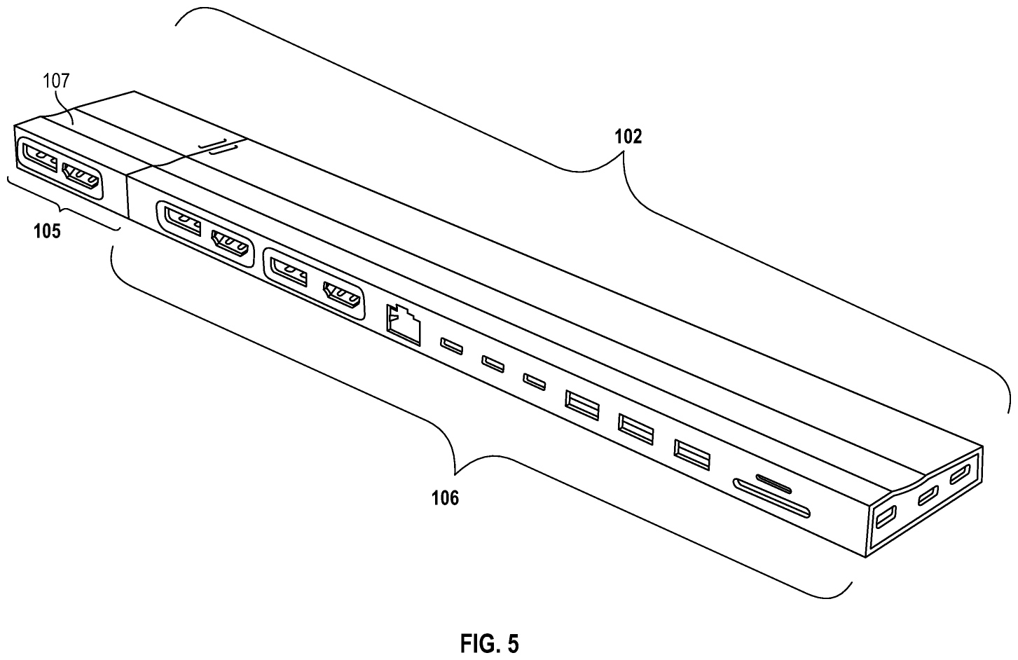

FIG. 5 illustrates a back/top view of an embodiment of the present invention with the extender portion attached to the main portion.

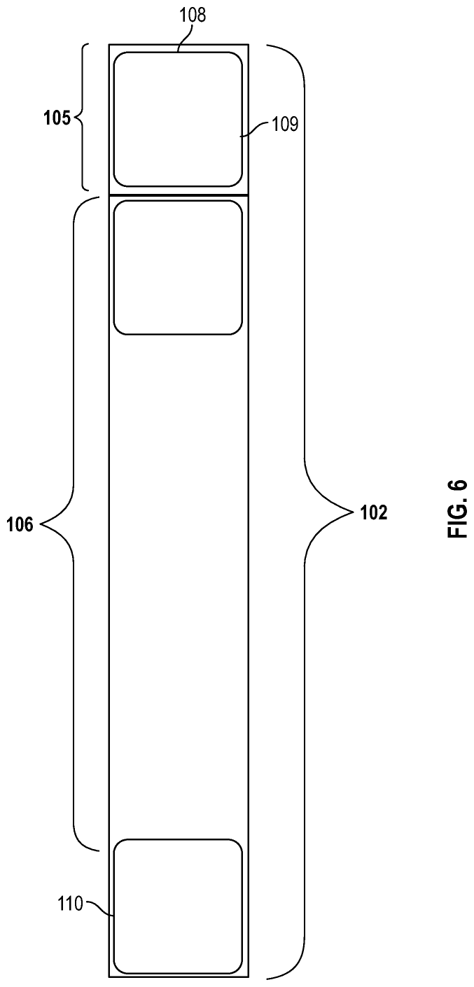

FIG. 6 illustrates a bottom view of an embodiment of the present invention with the extender portion attached to the main portion.

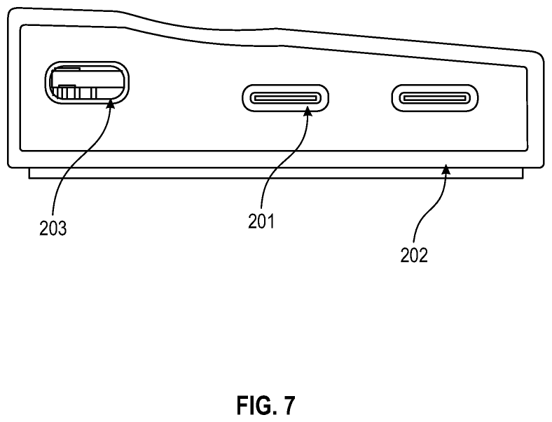

FIG. 7 illustrates a right-hand side view of an embodiment of the present invention, specifically the extender portion for the 16″ MacBook, with two USB C ports to attach to the laptop.

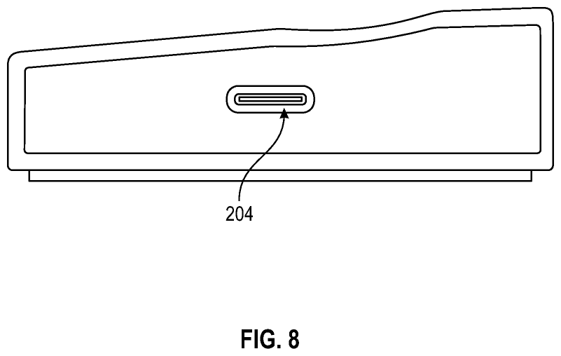

FIG. 8 illustrates a left-hand side view of an embodiment of the present invention, specifically the main portion for the 13″ MacBook, with a single USB C port to attach to the laptop.

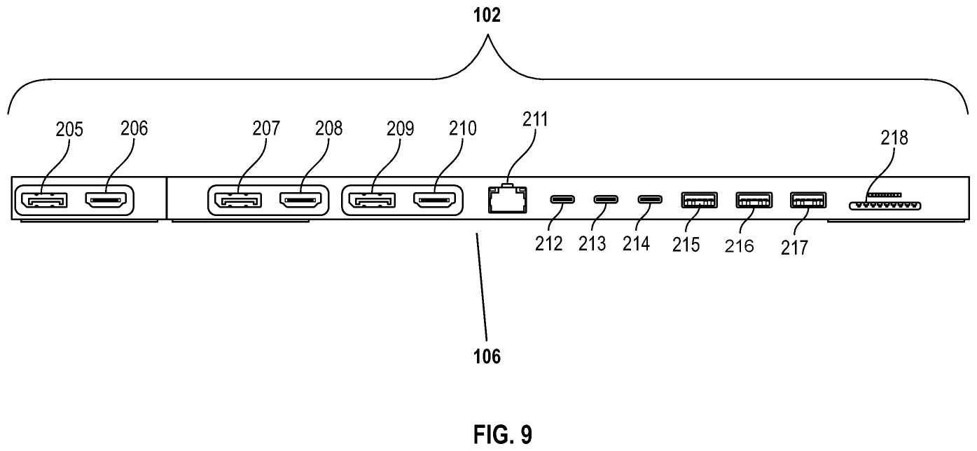

FIG. 9 illustrates a back view of an embodiment of the present invention with the extender portion attached to the main portion, showing each of the fifteen inputs.

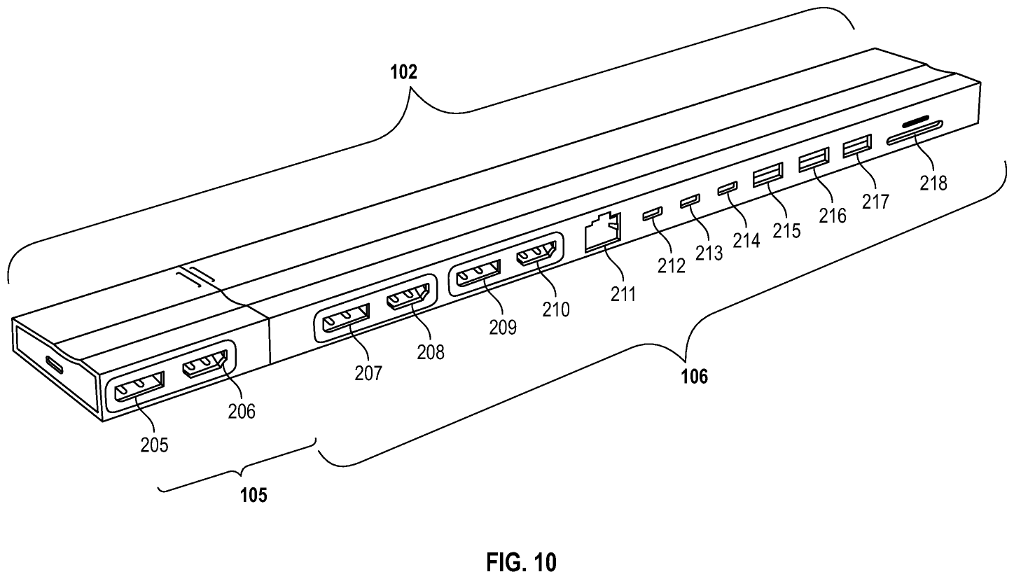

FIG. 10 illustrates a back/top view of an embodiment of the present invention with the extender portion attached to the main portion, showing each of the fifteen inputs.

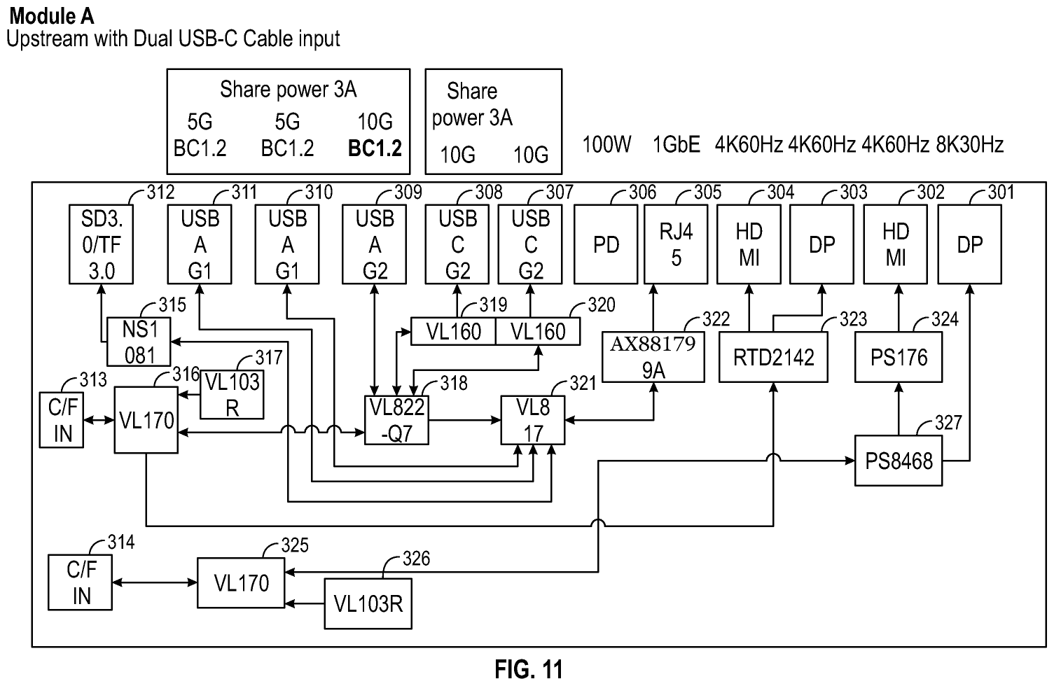

FIG. 11 illustrates a circuit or block diagram showing the layout of the present invention's main portion.

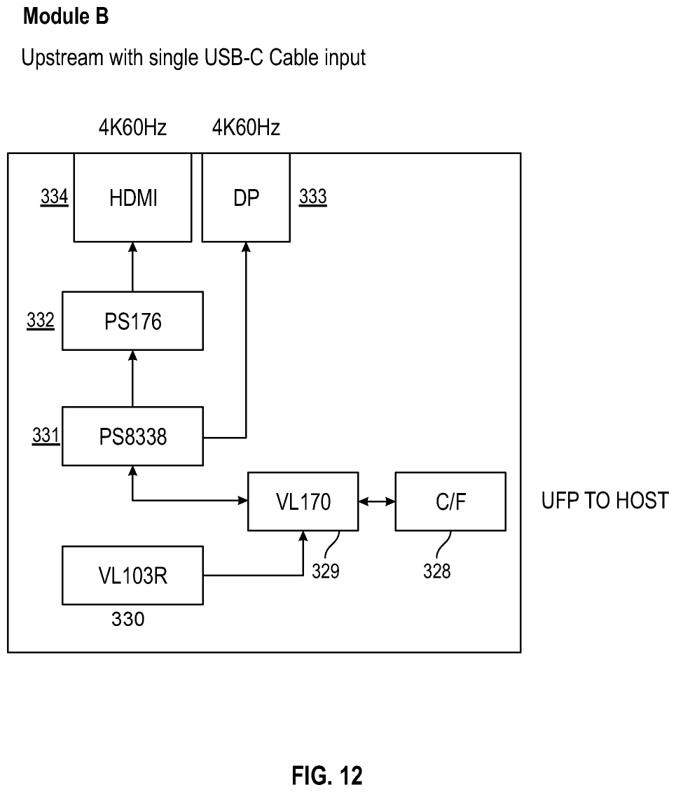

FIG. 12 illustrates a circuit or block diagram showing the layout of the present invention's extender portion.

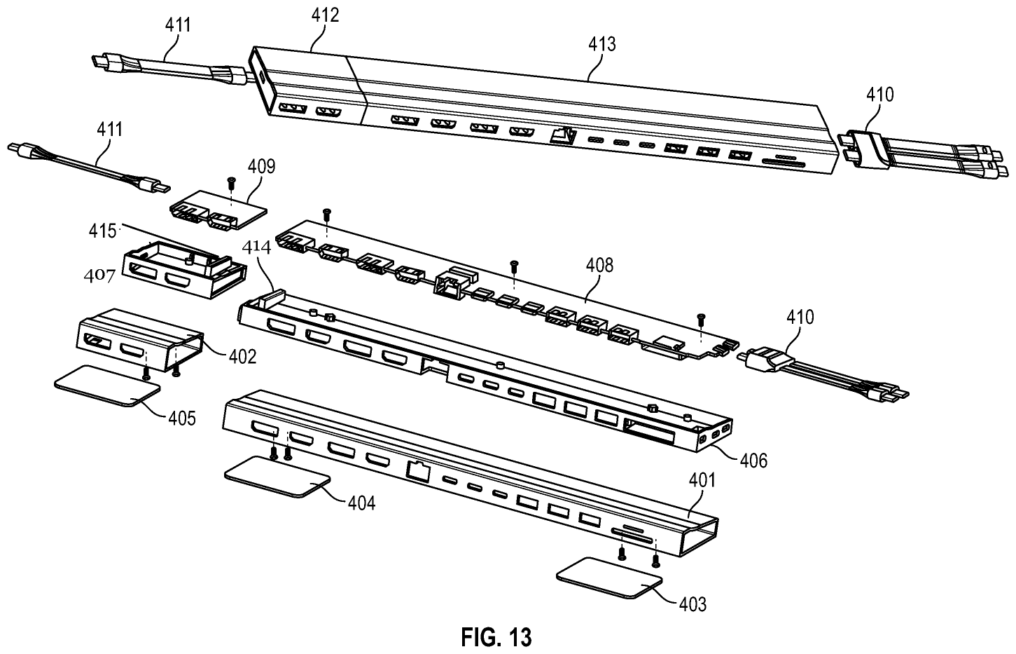

FIG. 13 illustrates an exploded view of a back plate of an embodiment of the present invention.

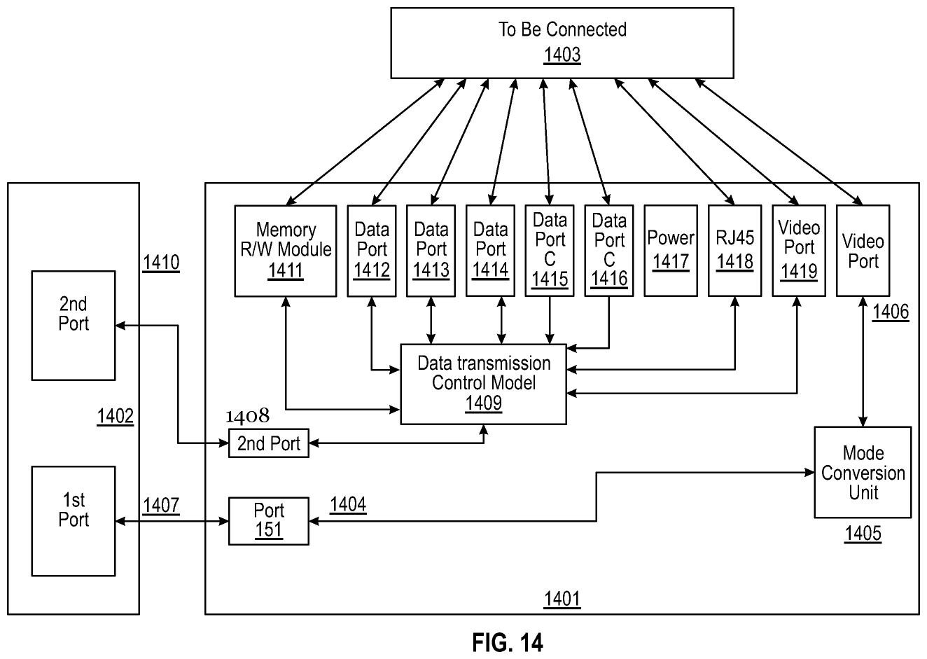

FIG. 14 illustrates a simplified circuit or block diagram showing the layout of the present invention's main portion and its external connecters.

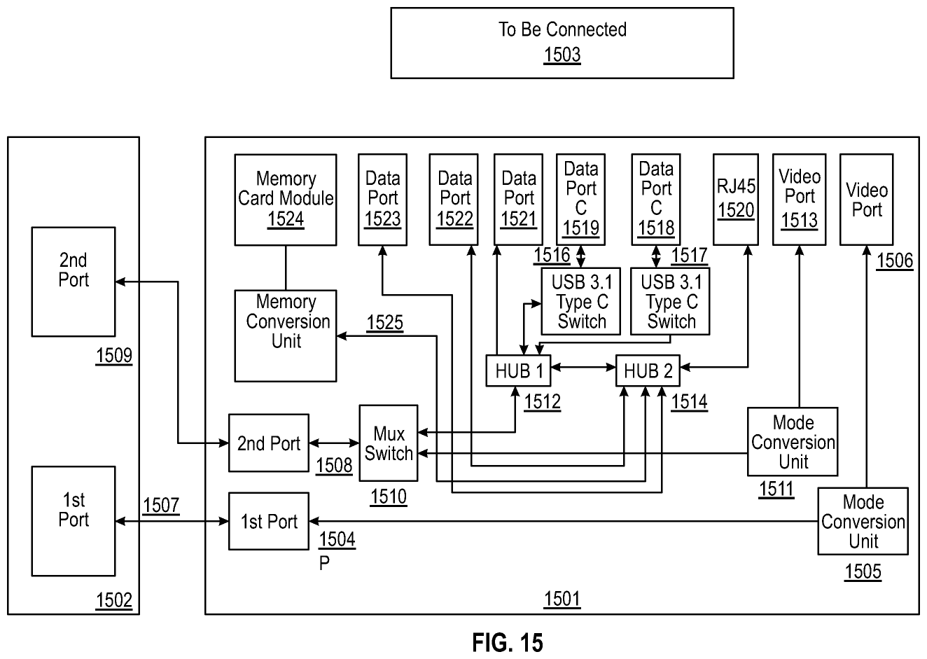

FIG. 15 illustrates a more complex circuit or block diagram showing the layout of the present invention's main portion and its external connecters.

### DETAILED DESCRIPTION

The invention will be described in the context of a preferred embodiment.

FIG. 1 illustrates a 16″ MacBook 101 with the complete assembled hub apparatus 102 comprising the main hub apparatus 106 and the extension hub apparatus 105. On the right-hand side of the laptop is the single connector to thunderbolt port 103 leaving one remaining thunderbolt port to be used for a thunderbolt device. On the left-hand side of the laptop is a dual connector to thunderbolt ports 104.

FIG. 2 illustrates a top view of the extender hub apparatus 105 comprising a single connector to thunderbolt port 103. On the top of the embodiment is a groove 107 to accommodate the rubber stands on the bottom of the laptop.

FIG. 3 illustrates a top view of the main hub apparatus 106 comprising a dual connector to thunderbolt port 104. On the top of the embodiment is a groove 107 to accommodate the rubber stands on the bottom of the laptop.

FIG. 4 illustrates a top/front angled view of the fully assembled hub apparatus 102 comprising the main hub apparatus 105 and the extension hub apparatus 106. On the top of the fully assembled embodiment is a groove 107 to accommodate the rubber stands on the bottom of the laptop.

FIG. 5 illustrates a top/back angled view of the fully assembled hub apparatus 102 comprising the main hub apparatus 105 and the extension hub apparatus 106. On the top of the fully assembled embodiment is a groove 107 to accommodate the rubber stands on the bottom of the laptop.

FIG. 6 illustrates a bottom view of the fully assembled hub apparatus 102 comprising the main hub apparatus 105 and the extension hub apparatus 106. On the bottom of the extension hub apparatus 106 is a rubber stand 108 to stabilize the fully assembled hub apparatus 102 when attached to a laptop. On the bottom of the right-hand side of the main hub apparatus 105 is the first rubber stand 109 to stabilize the fully assembled hub apparatus 102 when attached to a laptop 101. On the bottom of the left-hand side of the main hub apparatus 105 is the second rubber stand 110 to stabilize the fully assembled hub apparatus 102 when attached to a laptop 101.

FIG. 7 illustrates a right-hand side view of the extender hub apparatus 106 comprising a first thunderbolt connector port 201 and a second thunderbolt connector port 202. On the back end of this view is a hub lock 203.

FIG. 8 illustrates a left-hand side view of the main hub apparatus 105 comprising a single thunderbolt connecter port 204.

FIG. 9 illustrates a back view of the fully assembled hub apparatus 102 comprising the main hub apparatus 105 attached to the extender hub apparatus 106. All input ports are shown, comprising the video attachments to the extender hub apparatus 106 as follows: a first DisplayPort input 205 and a first HDMI input 206. The video attachments to the main hub apparatus 105 are as follows: a second DisplayPort input 207, a second HDMI input 208, a third DisplayPort input 209, and a third HDMI input 210. The main hub apparatus 105 goes on to include the following inputs: an Ethernet jack 211, a USB-C PD Power Input port 212, a first USB C input 213, a second USB C input 214, a first USB-A input 215, a second USB-A input 216, a third USB-A input 217, and a memory card reader 218.

FIG. 10 illustrates an angled top/back view of the fully assembled hub apparatus 102 comprising the main hub apparatus 105 attached to the extender hub apparatus 106. The main hub apparatus 105 can be separated from the extender hub apparatus 106 easily since the two are connected by magnetic mechanism. All input ports are shown, comprising the video attachments to the extender hub apparatus 106 as follows: a first DisplayPort input 205 and a first HDMI input 206. The video attachments to the main hub apparatus 105 are as follows: a second DisplayPort input 207, a second HDMI input 208, a third DisplayPort input 209, and a third HDMI input 210. The main hub apparatus 105 goes on to include the following inputs: an ethernet jack 211, a power port 212, a first USB C input 213, a second USB C input 214, a first USB-A input 215, a second USB-A input 216, a third USB-A input 217, and a memory card reader 218.

FIG. 11 illustrates a schematic or block diagram of the circuits within the main hub apparatus 105, showing each input and how it is routed to the dual thunderbolt connector module 104, comprising of a first connector port to the laptop's thunderbolt port 313 and a second connector port to the laptop's thunderbolt port 314. The circuits for the input ports are as follows: a second DisplayPort input module 301, a second HDMI input module 302, a third DisplayPort input module 303, a third HDMI input module 304, an ethernet module connector module 305, a power port module 306, a first USB C input 307, a second USB C input 308, a first USB-A input 309, a second USB-A input 310, a third USB-A input 311, and a memory card reader 312. A power port module 306 lies in the center of the inputs on the main hub apparatus 105. A USB switch module 316 (an exemplary embodiment is VL170 4×6 USB Type-C alternate Mode MUX by Via Labs, Inc.) is the first chip, controlling the traffic from the various inputs and connecting the first connector port to the laptop's thunderbolt port 313 to several other circuits, to wit:
1. A USB-A controller module 317 (an exemplary embodiment is VL103 DP Alt-mode & PD 3.0 Controller by Via Labs, Inc.), which controls the switch module 316;
2. A USB hub controller module 318 (an exemplary embodiment is VL822 SuperSpeed USB 10 Gbps Hub Controller by Via Labs, Inc.), which further connects directly to the first USB-A port 309, and through a first USB hub switch module 319 and second USB hub switch module 320 (an exemplary embodiment for 319 and 320 is VL160 Type-C Switch (CCMode) chip by Via Labs, Inc.); connects to the first USB C port module 307 and second USB C port module 308. The USB hub controller module 318 (an exemplary embodiment is VL822 SuperSpeed USB 10 Gbps Hub Controller by Via Labs, Inc.) further connects the first USB-A port module 309;
3. Also connecting to the USB switch module 316 through the USB hub controller module 318 is a USB 3.1 controller module 321 (an exemplary embodiment is VL817 (BO) USSB 3/1 Gen 1 Hub Controller by Via Labs, Inc.). The USB 3.1 controller module 321 connects to a flashcard controller module 315 (an exemplary embodiment is NS1081 Flash Card controller by Norelsys) which itself is connected to the memory card reader module 312. The USB 3.1 controller module 321 (an exemplary embodiment is V817 USB 3.1 Gen 1 Hub Controller by Via Labs, Inc.) directly connects to the second USB-A module 310 and third USB-A module 311. The USB 3.1 controller module further connects to the ethernet module connector module 305 through a gigabit ethernet controller 322 (an exemplary embodiment is AX88179 USB-A to 10/100/1000M Gigabit Ethernet Controller by Parade Technologies, Inc.); and
4. A display HDMI hub module 323 (an exemplary embodiment is RTD2142-CG DisplayPort Multimedia Hub by Realtek Semiconductor Corp), which further connects to the third DisplayPort 303 and third HDMI port 304.

A USB switch module 325 controlling the traffic from the various inputs connects the second connector port to the laptop's thunderbolt port 314 to several other circuits, to wit:
1. A USB-A controller module 326 (an exemplary embodiment is VL103 DP Alt-mode & PD 3.0 Controller by Via Labs, Inc.), which controls the switch module 325 (an exemplary embodiment is VL170 4×6 USB Type-C Alternate Mode MUX by Via Labs, Inc.);
2. A jitter or distortion cleaning and demultiplexer module 327 (an exemplary embodiment is PS8468DP 1.4 Dual-Mode Jitter Cleaning Demultiplexer by Parade Technologies, Inc.), which itself connects to a DisplayPort to HDMI converter 324 (an exemplary embodiment is PS176 DisplayPort to HDMI 2.0 Protocol Converter by Parade Technologies, Inc.), which connects to the second DisplayPort 301 and second HDMI port 302. This is a direct path from the video ports 301 and 302 to the second connector port to thunderbolt 314, which provides for faster and high-quality video than a shared switch such as those connecting to the first connector port to thunderbolt 313.

FIG. 12 illustrates a schematic or block diagram of the circuits within the extender hub apparatus 106, comprising each input and how it is routed to the single thunderbolt connector 103. A USB switch 329 (an exemplary embodiment is VL170 4×6 USB Type-C Alternate Mode MUX by Via Labs, Inc.) connects the single port connector to thunderbolt 328 to the following:
1. A USB-A controller module 330 (an exemplary embodiment is VL103 DP Alt-mode & PD 3.0 Controller r by Via Labs, Inc.);
3. A jitter or distortion cleaning and demultiplexer module 331 (an exemplary embodiment is PS8338 DisplayPort v 1.2 Dual-Mode Source Demutiplexer by Parade Technologies, Inc.), which itself connects to a DisplayPort to HDMI converter 332 (an exemplary embodiment is PS176 Display Port to HDMI 2.0 Protocol Converter by Parade Technologies, Inc.) which connects to the first DisplayPort 334 and first HDMI port 335. This is a direct path from the video ports 334 and 335 to the single connector port to thunderbolt 328, which provides a second channel for faster and high-quality video.

FIG. 13 illustrates an exploded view of an embodiment of this invention. In this embodiment, a chassis for the main hub apparatus 401 is attached to two rubber stands 403, 404. The chassis for the extender hub apparatus 402 is attached to one rubber stand 405. These provide for stability once the invention is connected to a laptop. The chassis base for the main hub apparatus 406 includes a magnet module 414, which secures the embodiment to the laptop when connected. Likewise, the chassis base for the extender hub apparatus 407 includes a magnet module 415. It is the intended design that the main hub apparatus 401 is attachable to extender hub apparatus 402. The main circuit board 408 is within the chassis 401; the extender circuit board 409 is within the chassis 402. The dual connector to the laptop's thunderbolt ports 410 attach to the left-hand side of the main hub apparatus 413, and the single connector to the laptop's thunderbolt port 411 attaches to the right-hand side of the extension hub apparatus 412.

FIG. 14 illustrates a simplified circuit or block diagram showing the layout of the present invention's main hub apparatus 1401 connected to the laptop 1402 and the external apparatuses 1403 to which the hub connects. The laptop's 1402 second port 1410 connects to the invention via the main hub apparatus' 1401 second port 1408, which in turn connects to a data transmission control module 1409. The data transmission control module 1409 connects to the memory card module 1411, three data ports 1412, 1413, 1414, two USB-C data ports 1415, 1416, an ethernet or RJ45 connecter 1418, and a video port 1419. The main hub apparatus 1401 also has a power port 1417. In one embodiment, the data transmission control module is a circuit or part of circuit that comprises chip sets that perform the tasks of switches, hub, to regulate the data transmission between multiple inputs. The laptop's 1402 first port 1407 connects directly to a mode conversion unit 1405, which in turn connects to a second video port 1406.

FIG. 15 illustrates a more complex circuit or block diagram showing the layout of the present invention's main portion 1501 connected to the laptop 1502 and the external apparatuses 1503 to which the hub connects. The laptop's 1502 second port 1509 connects to the main hub's 1501 second port 1508, which itself connects to a multiplexer switch module (MUX) 1510. The MUX switch 1510 connects to the following:
1. A mode conversion unit 1511, connecting to the first video port 1513.
2. The first hub 1512, which connects to one data port 1521.
3. The first hub 1512 also connects to two USB 3.1 type C switches 1516, 1517, each of which respectively connects to data port C 1519, 1518.
4. The first hub 1512 finally connects to the second hub 1514.
   a. The second hub 1514 connects to a memory card conversion unit 1525, which in turn connects to the memory card module port 1524.
   b. The second hub 1514 also connects to an Ethernet port (RJ45) 1520.
   c. The second hub 1514 further connects to two data ports (USB type A) 1523, 1522.

The laptop's 1502 first port 1507 connects to the main hub apparatus' first port 1504, which connects to a mode conversion unit 1505, which itself connects to the second video port 1506. In one embodiment, the mode conversion unit is a circuit or part of circuit that comprises chipsets that perform the task of modifying the video data from DisplayPort standard to HDMI standard. In another embodiment, the mode conversion unit is a circuit or part of circuit that comprises chipsets that performs the task of filtering and stabilizing the quality of video transmission data. In one embodiment, the laptop's 1502 first port 1507 connects to the main hub apparatus' first port 1504, which itself connects to the second video port 1506.

1. A port extension apparatus for extending ports of an end-user device comprising:
a. a connecting port module for connecting to an end-user device, the connecting port module having first and second port units;
b. a first video port module operatively connecting to the first port unit;
c. a data transmission control module operatively connecting to the second port unit via a first data transmission port of the data transmission control module;
d. a second video port module operatively connecting to a second data transmission port of the data transmission control module; and
e. a data port module operatively connecting to a third data transmission port of the data transmission control module; wherein
f. when a to-be-connected device connects to the first video port module, the first video port module and the connecting port module form a transmission path enabling video data transmission between the to-be-connected device and the end-user device;
g. when a to-be-connected device connects to the second video port module, the data transmission control module controls video data transmission between the to-be-connected device and the end-user device;
h. and when a to-be-connected device connects to the data port module, the data transmission control module controls data transmission between the to-be-connected device and the end-user device.

2. Apparatus of claim 1 wherein said end-user device is a display device.

3. Apparatus of claim 1 wherein said first video port module when operatively connecting to the first port unit is further consist of a mode conversion unit between the first video port module and the first port unit.

4. Apparatus of claim 3, wherein said mode conversion unit is comprised of a video feed conversion unit that converts video feed from DisplayPort standard to HDMI port standard.

5. Apparatus of claim 3, wherein said mode conversion unit is comprised of jitter cleaning module to improve the quality of the video transmission data.

6. The Apparatus of claim 1, further comprising: a second data port module operatively connecting to a fourth data transmission port of the data transmission control module; and a memory card R/W (read/write) module operatively connecting to at least one data read/write port of the data transmission control module.

7. The port extension apparatus as described in claim 6, further comprising: a third data port module operatively connecting to a fifth data transmission port of the data transmission control module.

8. The port extension apparatus as described in claim 7, further comprising: a fourth data port module operatively connecting to a sixth data transmission port of the data transmission control module.

9. The port extension apparatus as described in claim 8, further comprising: a fifth data port module operatively connecting to a seventh data transmission port of the data transmission control module.

10. The port extension apparatus as described in claim 1, wherein the first video port module comprises an HDMI (High-Definition Multimedia Interface) port, and a a DP (Display Port).

11. The port extension apparatus as described in claim 1, wherein the second video port module comprises an HDMI port, and a Display Port.

12. The port extension apparatus as described in claim 1, wherein the first data port module comprises a Type-C female port or a Lighting female port.

13. The port extension apparatus as described in claim 6, wherein the second data port module comprises a Type-C female port or a Lighting female port.

14. The port extension apparatus as described in claim 7, wherein the third data port module comprises a USB female port.

15. The port extension apparatus as described in claim 1, further comprising a detachable secondary port extension apparatus wherein said detachable secondary port extension apparatus is attachable to said port extension apparatus via a magnetized mechanism.

16. The port extension apparatus as described in claim 15, wherein said detachable secondary port extension apparatus wherein said detachable secondary port extension apparatus is comprised of
a. a secondary port extension connecting port module for connecting to said end-user device, the secondary port extension connecting port module having a first secondary port extension port unit;
b. a first secondary port extension video port module operatively connecting to the first port unit;
c. when said to-be-connected device connects to said first secondary port extension video port module, the first secondary port extension video port module and the secondary port extension connecting port module form a transmission path enabling video data transmission between said to-be-connected device and said end-user device.

17. A port extension apparatus for extending ports of an end-user device comprising:
a main hub and an extension hub;
wherein said main and extension hubs comprises rectangular prism chassis that have multiple openings on sides for ports;
wherein said main hub, from left to right looking in, comprises a first DisplayPort port, a first HDMI port, a second DisplayPort port, a second HDMI port, an Ethernet port, 3 USB-C ports, 3 USB-A ports, a micro memory card port and a memory card port;
wherein said main hub further comprises a dual Thunderbolt ports on a right side of said main hub that in turn connects to a dual Thuderbolt connector;
wherein said extension hub, from left to right, comprises a DisplayPort port and a HDMI port; wherein said extension hub further comprise a single Thunderbolt port on a left side of said extension hub that in turn connects to a single Thunderbolt connector;
wherein said main hub further comprises a first circuit board on which said first DisplayPort port, first HDMI port, second DisplayPort port, second HDMI port, Ethernet port, 3 USB-C ports, 3 USB-A ports, micro memory card port, memory card port, and dual Thunderbolt ports are mounted, and wired;
wherein said extension hub further comprises a second circuit board on which said DisplayPort port, HDMI port, and single Thunderbolt port are mounted and wired;
wherein said main hub further comprises three screws that attach said first circuit board to said main rectangular prism chassis and are disposed at an equidistance;
wherein said extension hub further comprises one screw that attach said second circuit board to said extension rectangular prism chassis;
wherein said main hub further comprises a first magnet module that secures said main hub to a laptop;
wherein said extension hub further comprises a second magnet module that secures said extension hub to a laptop;
wherein said main hub further comprises two rubber pads and four screws that attach said two rubber pads to a bottom of said main rectangular prism chassis at an equidistance;
wherein said extender hub further comprises a rubber pad and two screws that attach said rubber pad to a bottom of said extension rectangular prism chassis.
